(19) United States
(12) Patent Application Publication
(10) Pub. No.: US 2011/0025656 A1
(43) Pub. Date: Feb. 3, 2011

(54) APPARATUS AND METHOD FOR DRIVING A DISPLAY PANEL

(75) Inventor: Chiao-Lin Huang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/900,484

(22) Filed: Oct. 8, 2010

Related U.S. Application Data
(63) Continuation-in-part of application No. 11/163,063, filed on Oct. 4, 2005.

(51) Int. Cl. G09G 5/00

(52) U.S. Cl. 345/204

(57) ABSTRACT

An apparatus and method of driving a display panel are provided. The apparatus includes a comparison unit and a source driver. The comparison unit receives and stores a current line data, and compares the current line data with a previous stored line data. When a pixel data within the current line data and another pixel data within the previous line data at the same position are not identical, the comparison unit outputs the pixel data of the current line data, and the source driver latches the pixel data for driving the display panel, which is output from the comparison unit. When the pixel data within the current line data and another pixel data within the previous line data at the same position are not identical, the comparison unit does not output the pixel data, and the source driver drives the display panel in accordance with the previously latched pixel data.

### CROSS-REFERENCE TO RELATED APPLICATION

This application is a continuation-in-part of and claims the priority benefit of a prior application Ser. No. 11/163,063, filed on Oct. 4, 2005, now pending. The entirety of the above-mentioned patent application is hereby incorporated by reference herein and made a part of this specification.

### BACKGROUND OF THE INVENTION

1. Field of the Invention

The present invention generally relates to a display apparatus, and more particularly, to an apparatus and a method for driving a display panel capable of reducing the amount of transmitted data required for displaying images.

2. Description of Related Art

In the conventional technology, each scan line in the display panel is driven by sequentially providing its corresponding line data to a driver that in turn drives each pixel in the corresponding scan line in the display panel in accordance with the received corresponding line data. For example, in a liquid crystal display apparatus, a gate driver is utilized to turn on each scan line in a liquid crystal display panel one by one, while using a source driver for transmitting the corresponding line data to the corresponding turned-on scan line in the liquid crystal display panel.

FIG. 1 shows a block diagram of a conventional liquid crystal display apparatus. Referring to FIG. 1, the liquid crystal display apparatus 100 comprises a timing controller 110, a gate driver 120, a source driver 130 and a liquid crystal display panel 140. In the liquid crystal display apparatus 100, the gate driver 120 is coupled to a plurality of scan lines in the liquid crystal display panel 140 (not shown) and the source driver 130 is coupled to a plurality of data lines in the liquid crystal display panel 140 (not shown). The timing controller 110 turns on each scan line in the liquid crystal display panel 140 one by one through the gate driver 120. Coordinating with a timing of the gate driver 120, the timing controller 110, through the source driver 130, transmits corresponding line data to the corresponding turned-on scan line in the liquid crystal display panel 140.

According to a sequence from left to right, the timing controller 110 sequentially transmits each pixel data of a certain scan line to the source driver 130 through a data bus DATA[0:n−1] with n bits. In the source driver 130, a shift register 131 transmits a latching signal EIO from its left stage to its right stage in accordance with a timing of a source clock signal S_CLK supplied from the timing controller 110. In other words, the shift register 131 at each output terminal, from left to right, sequentially outputs the latching signal EIO to a data-latching device 132. The data-latching device 132 is able to latch the data of the data bus DATA[0:n−1] into its internal corresponding position in accordance with the latching signal output from the shift register 131. In addition, an output-converting unit 133 respectively converts each data latched inside the data-latching device 132 to its corresponding analog data that then drives a corresponding data line in the liquid crystal display panel 140.

However, in many applications, for example, editing operations in a personal computer, pixel data at their corresponding position (or at the same position) in two neighboring scan lines are always identical; that is, the pixel data, transmitted from the timing controller 110 to the source driver 130, at their corresponding position in a current scan line and in a previous scan line, are identical. For simplifying the description of this embodiment, it is assumed that each pixel data has 256 grey scales and a RSDS technology is used as an interface (i.e. the rising edge and falling edge of a clock signal are both used as latching signals) between the timing controller 110 and the source driver 130. FIG. 2 shows signal timing charts of a whole picture with a grey scale of 85 (i.e. pixel data is 01010101) transmitted by the timing controller 110 in the liquid crystal display apparatus 100. Referring to FIG. 1 and FIG. 2, as the rising edge and the falling edge of the clock signal are both latching signals, during a clock signal period, each bit line of the data bus DATA[0:n−1] is able to transmit two bits of data. Consequently, the 0^{th} and 1^{st} bits of the pixel data ┌01010101┘ are transmitted to the data-latching device 132 through the data bus DATA[0], the 2^{nd} and 3^{rd} bits of the pixel data ┌01010101┘ are transmitted to the data-latching device 132 through the data bus DATA[1], and so on.

Evidently, from FIG. 2, it can be seen that although pixel data at a corresponding position in a previous line data and a later line data (i.e. scan line data) are identical, the prior art still transmits the same data again. As there are consistently a great amount of data transmitted in the data bus DATA[0:n−1] and data are always repeated one after another in the transmitted data, unnecessary power consumption and electromagnetic interference (EMI) would occur.

### SUMMARY OF THE INVENTION

Accordingly, the present invention is directed to an apparatus for driving a display panel, which is able to determine whether pixel data at their corresponding position in a current and a previous scan line is identical, before transmitting the pixel data to a source driver. When the pixel data at their corresponding position in a current and a previous scan lines is determined to be identical, the source driver directly uses previously latched pixel data, rather than transmitting the pixel data repeatedly. Hence, the amount of transmitted data required for displaying pictures is reduced, which further reduces the power consumption and electromagnetic interference (EMI).

The present invention is further directed to a method for driving a display panel, which is able to determine whether pixel data at their corresponding position in a current and a previous scan lines is identical, for determining whether a source driver latches the pixel data. Therefore, an amount of data transmitted by a source driver and required for displaying images is reduced, which further reduces the power consumption and electromagnetic interference (EMI).

Based on the aforementioned and other objectives, the present invention provides an apparatus for driving a display panel. The apparatus comprises a comparison unit and a source driver. The comparison unit receives and stores a current line data. The comparison unit has received a previous line data before receiving the current line data, in which the previous line data comprises a plurality of previous pixel data and the current line data comprises a plurality of current pixel data, and the plurality of previous pixel data are positionally corresponding to the current pixel data respectively. The comparison unit compares a predetermined one of the plurality of the current pixel data with the corresponding one of the plurality of previous pixel data. When the predetermined one current pixel data and the corresponding one previous pixel data are not identical, the comparison unit outputs an enable control signal and the current line data. When the predetermined one current pixel data and the corresponding one previous pixel data are identical, the comparison unit outputs a disable control signal and does not output the current line data. The source driver is coupled to the comparison unit, and latches the current line data output from the comparison unit and then drives the display panel in accordance with the current line data when a control signal is the enable control signal, or drives the display panel in accordance with the previous latched line data when the control signal is the disable control signal.

Based on the aforementioned and other objectives, the present invention provides an apparatus for driving a display panel. The apparatus comprises a comparison unit, a latch control unit, a data-latching unit and an output-converting unit. The comparison unit has previously received a previous line data comprising a plurality of previous pixel data and stores a current line data comprising a plurality of current pixel data. The plurality of previous pixel data and the plurality of current pixel data are positionally corresponding to each other respectively. The comparison unit compares a predetermined one of the plurality of current pixel data with the corresponding one of the plurality of previous pixel data, and outputs a control signal and determining whether to output the current line data in accordance with the comparison result. The latch control unit, coupled to the comparison unit, outputs a plurality of latching signals and determines whether to output each latching signal in accordance with the control signal output from the comparison unit. A data-latching unit, coupled to the latch control unit, determines whether to latch corresponding pixel data in the current line data output from the comparison unit in accordance with the latching signals output from the latch control unit. The output-converting unit, coupled between the data-latching unit and the display panel, converts data latched inside the data-latching unit into an analog data for driving a plurality of data lines in the display panel.

Based on the aforementioned and other objectives, the present invention provides a method for driving a display panel. In the method, a previous line data comprising a plurality of previous pixel data is received and stored. A current line data comprising a plurality of current pixel data is then received and stored. The plurality of current pixel data and the plurality of previous pixel data are corresponding to each other respectively. A predetermined one of the plurality of current pixel data is compared with the corresponding one of the plurality of previous pixel data. The pixel data within the current line data is latched into the source driver when the predetermined one of the plurality of current pixel data compared with the corresponding one of the plurality of previous pixel data is not identical. The source driver is enabled to keep the previously latched pixel data when the predetermined one of the plurality of current pixel data compared with the corresponding one of the plurality of previous pixel data is identical to each other. The source driver is enabled to drive the display panel in accordance with each internal latched pixel data.

Based on the aforementioned and other objectives, the present invention provides an apparatus for driving a display panel. The apparatus comprises a comparison unit and a source driver. The comparison unit receives and stores a current line data. The comparison unit has received a previous line data before receiving the current line data. The comparison unit compares only a part of the current line data with the corresponding part of the previous line data. When the part of current line data and the corresponding part of previous line data are not identical, the comparison unit outputs an enable control signal and the current line data. When the predetermined one current pixel data and the corresponding one previous pixel data are identical to each other, the comparison unit outputs a disable control signal and does not output the current line data. The source driver, coupled to the comparison unit, latches the current line data output from the comparison unit and then drives the display panel in accordance with the current line data when a control signal is the enable control signal, or drives the display panel in accordance with the previous latched line data when the control signal is the disable control signal.

Based on the aforementioned and other objectives, the present invention provides a method for driving a display panel. In the method, a previous line data and a current line data are sequentially received and stored. Only a part of the current line data is compared with a corresponding part of the previous line data. A pixel data within the current line data is latched into the source driver, when the part of the current line data and the corresponding part of the previous line data being compared are not identical. The source driver is enabled to keep the previously latched pixel data when the part of the current line data and the corresponding part of the previous line data being compared are identical. The source driver is enabled to drive the display panel in accordance with each internal latched pixel data.

In the present invention, the comparison unit is used to compare the pixel data within the current line data with the corresponding pixel data within the previous line data. When the comparison result shows that they are identical, the source driver directly uses the previously latched pixel data, rather than transmitting the pixel data repeatedly. Hence, the amount of transmitted data required for displaying pictures is reduced, which further reduces the power consumption and electromagnetic interference (EMI).

The objectives, other features and advantages of the invention will become more apparent and easily understood from the following detailed description of the invention when taken in conjunction with the accompanying drawings.

### BRIEF DESCRIPTION OF THE DRAWINGS

The accompanying drawings are included to provide further understanding of the invention and are incorporated in and constitute a part of this specification. The drawings illustrate embodiments of the invention and, together with the description, serve to explain the principles of the invention.

FIG. 1 shows a block diagram of a conventional liquid crystal display apparatus.

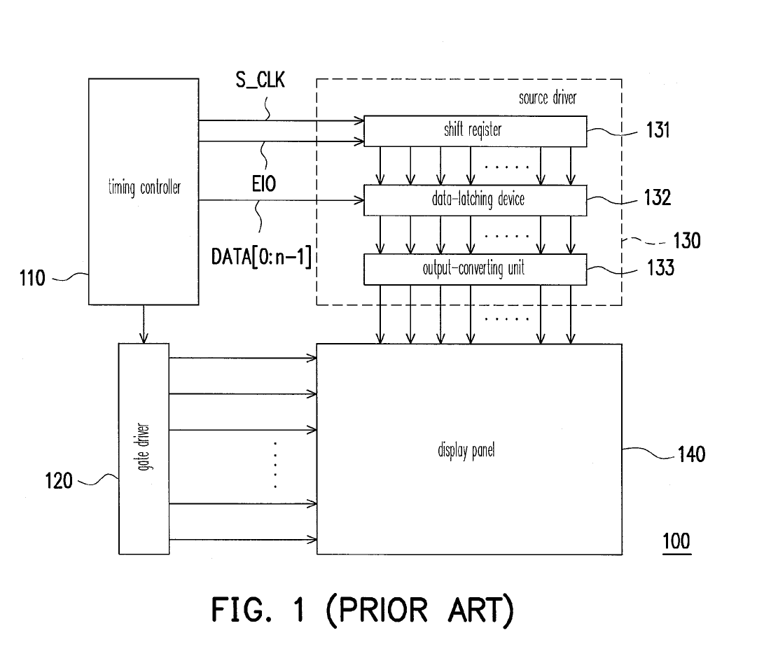

FIG. 2 shows signal timing charts of a whole picture with a grey scale of 85 (i.e. pixel data is 01010101) transmitted by the timing controller in the liquid crystal display apparatus shown in FIG. 1.

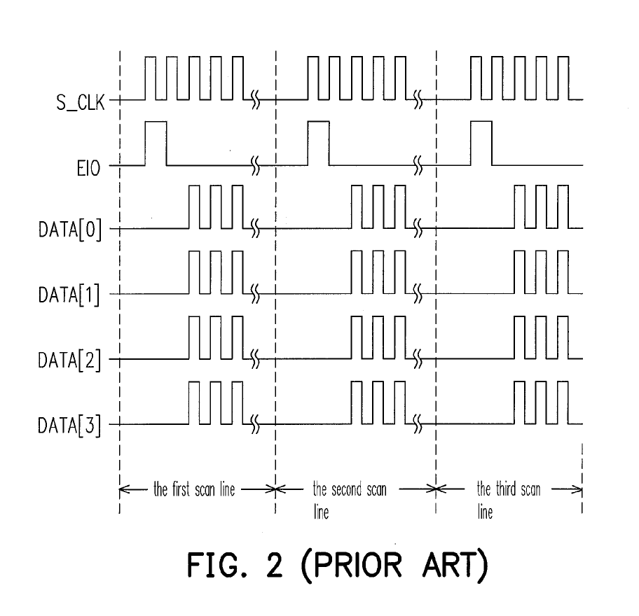

FIG. 3 shows a block diagram of a liquid crystal display apparatus according to an embodiment of the present invention.

FIG. 4 shows embodiments of a timing controller and a source driver shown in FIG. 3.

FIG. 5 shows signal timing charts of a whole picture with a grey scale of 85 (i.e. pixel data is 01010101) transmitted by the timing controller in the liquid crystal display apparatus shown in FIG. 4.

FIG. 6 shows a comparator embodiment shown in FIG. 4.

### DESCRIPTION OF THE EMBODIMENTS

Reference will now be made in detail to an apparatus and a method for driving a display panel, examples of which are illustrated in the accompanying drawings. Wherever possible, the same reference numbers are used in the drawings and the description to refer to the same parts. For a purpose of describing the present invention, the following embodiments take a liquid crystal display apparatus as an example; however, one of ordinary skill in the art may modify these embodiments to other display apparatus and methods without departing from the scope of the present invention.

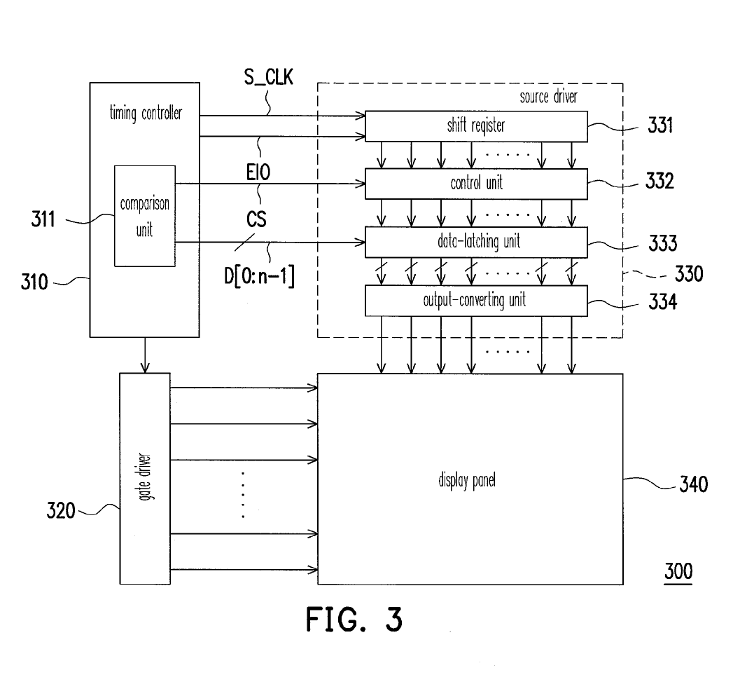

FIG. 3 shows a block diagram of a liquid crystal display apparatus according to an embodiment of the present invention. Referring to FIG. 3, the liquid crystal display apparatus 300 comprises a timing controller 310, a gate driver 320, a source driver 330 and a liquid crystal display panel 340. Besides, in the liquid crystal display apparatus 300, the gate driver 320 is coupled to a plurality of scan lines in the liquid crystal display panel 340 (not shown) and the source driver 330 is coupled to a plurality of data lines in the liquid crystal display panel 340 (not shown). The timing controller 310 turns on each scan line in the liquid crystal display panel 340 one by one through the gate driver 320. Coordinating with the timing of the gate driver 320, the timing controller 310, through the source driver 330, transmits corresponding line data to the corresponding turned-on scan line in the liquid crystal display panel 340.

In this embodiment, although a comparison unit is disposed inside the timing controller 310, one of ordinary skill in the art may, if necessary, dispose the comparison unit 311 outside the timing controller 310. The comparison unit 311 receives and stores a current line data (i.e. a plurality of pixel data in a scan line to be currently activated) in accordance with a scan timing, and compares the current line data with the previously stored line data (for example, a plurality of pixel data in a previous scan line). When a pixel data within the current line data and another pixel data within the previous line data at the same position are not identical (in fact, the aforementioned pixel data and another pixel data are numerals per se so that the term of “identical” means these data represent the same numeral), the comparison unit 311 outputs the pixel data of the current line data (through the data bus D[0:n−1]) and an enable control signal CS to the source driver 330. In the meantime, the source driver 330 latches the current line data in the data bus D[0:n−1] in accordance with the enable control signal CS and a first latching signal EIO. More, the source driver 330 drives the liquid crystal display panel 340 in accordance with the current line data. However, when the pixel data within the current line data and another pixel data within the previous line data at the same position are identical, the comparison unit outputs a disable control signal and does not output the pixel data (here outputs a logic “low”). Meanwhile, the source driver 330 drives the liquid crystal display panel 340 in accordance with the previously latched line data.

That is, the pixel data within the current line data are positionally corresponding to another pixel data within the previous line data. The comparison unit 311 compares a part of the pixel data within the current line data with a corresponding part of the pixel data within the previous line data. The comparison unit 311 does not have to compare other remaining part of the pixel data except for the part within the current line data with other remaining part of the pixel data within the previous line data. If the comparing result is that the part of the pixel data within the current line data with the corresponding part of the pixel data within the previous line data are not identical, the comparison unit 311 outputs the pixel data of the current line data (through the data bus D[0:n−1]) and an enable control signal CS to the source driver 330. If the comparing result is that the part of the pixel data within the current line data with the corresponding part of the pixel data within the previous line data are identical to each other, the comparison unit 311 outputs a disable control signal and does not output the pixel data (here outputs a logic “low”), and the source driver 330 drives the liquid crystal display panel 340 in accordance with the previously latched line data.

In the aforesaid embodiment, the comparison unit 311 only compares a part of the pixel data within the current line data with a corresponding part of the pixel data within the previous line data. The comparison unit 311 does not have to compare other remaining part of the pixel data except for the part within the current line data with other remaining part of the pixel data within the previous line data. That is, the remaining part of the pixel data could be neglected, and whether the remaining part of the pixel data except for the part within the current line data and other remaining part of the pixel data within the previous line data are identical or not will not affect the consequence of the comparison result. In one embodiment, the comparison unit 311 may compare a predetermined one of the pixel data within the current line data with a corresponding one of the pixel data within the previous line data, without having to compare other remaining part of the pixel data except for the predetermined one within the current line data with other remaining part of the pixel data except for the corresponding one within the previous line data.

The source driver 330 may, for example, comprise a latch control unit, a data-latching unit 333 and an output-converting unit 334. Besides, the latch control unit for outputting a plurality of latching signals to the data-latching unit 333 is coupled to a comparison unit 311. The latch control unit further determines whether to output each latching signal in accordance with the control signal CS output from the comparison unit 311. The latch control unit may, for example, comprise a shift register 331 and a control unit 332. The shift register 331 transmits the received latching signal EIO by stages inside the shift register 331 in accordance with a timing of the source clock signal S_CLK. In other words, the shift register 331, at each output terminal, from left to right, sequentially outputs a second latching signal to the control unit 332. More, the control unit 332 determines whether to pass the second latching signal output from the shift register 331 to the data-latching unit 333 in accordance with the control signal CS output from the comparison unit 311. In addition, the data-latching unit 333 determines whether to latch the current line data output from the comparison unit 311 through the data bus DATA[0:n−1]. The output-converting unit 334 is coupled between the data-latching unit 333 and the liquid crystal display panel 340. In addition, the output-converting unit 334 converts each line data latched inside the data-latching unit 333 into analog data that then drives the data lines in the liquid crystal display panel 340.

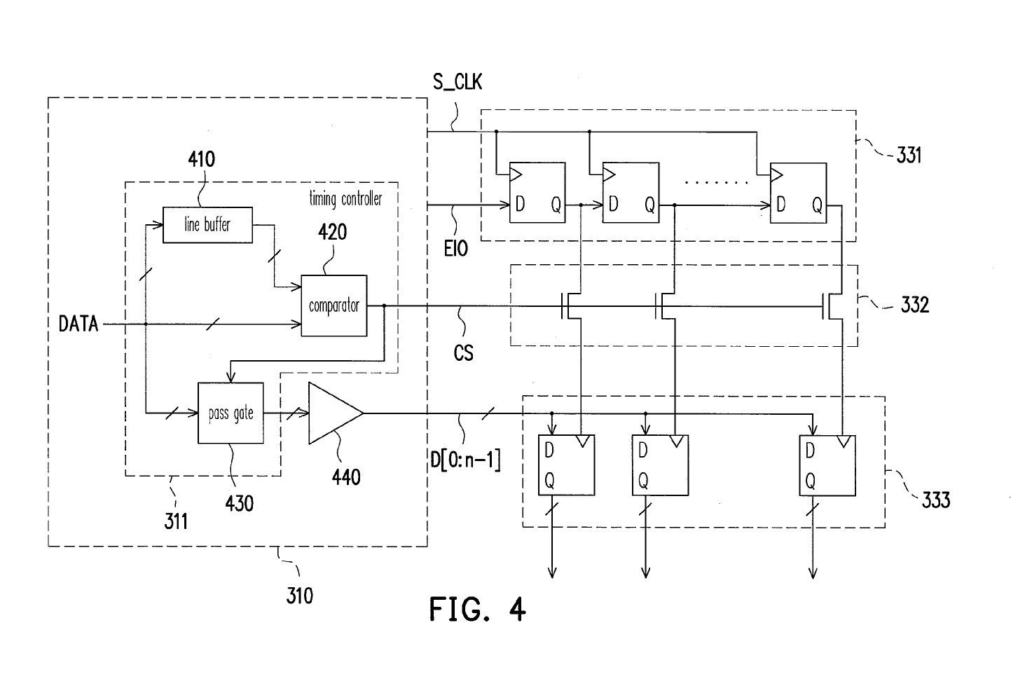

FIG. 4 shows embodiments of a timing controller 310 and a source driver 330 shown in FIG. 3. In the source driver 330, the shift register 331 may, for example, comprise D-type Flip-Flops connected in series, so may the data-latching unit 333. In the shift register 331, a trigger terminal of each D-type Flip-Flop is coupled to the source clock signal S_CLK. According to a timing of the source clock signal S_CLK, the first latching signal EIO is transmitted by stages to the D-type Flip-Flops. More, an output of each D-type Flip-Flop is the second latching signal.

Referring to FIG. 4, the control unit 332 comprises a plurality of switches. This embodiment is implemented by N-type transistors as the switches of the control unit 332. Each switch comprises a first terminal coupled to its corresponding output terminal of the shift register 331 (i.e. coupled to the output terminal of the corresponding D-type Flip-Flop in the shift register 331), a second terminal coupled to its corresponding latch control terminal of the data-latching unit 333 (i.e. coupled to a trigger terminal of the corresponding D-type Flip-Flop in the data-latching unit 333). More, each switch further comprises a control terminal that concurrently receives the control signal CS. Each switch determines whether to connect the first terminal and second terminal in accordance with the control signal CS.

Each D-type Flip-Flop in the data-latching unit 333 is triggered by its corresponding latching signal output from the control unit 332 to latch the corresponding pixel data in the current line data of the data bus DATA[0:n−1]. The output-converting unit 334 converts the data latched in each D-type Flip-Flop in the data-latching unit 333 to analog data that then drives the data lines in the liquid crystal display panel 340.

In this embodiment, the comparison unit 311 comprises a line buffer 410, a comparator 420 and a pass gate 430. The line buffer 410 receives and stores the current line data ODATA, as well as outputs the previously stored line data BDATA. The comparator 420 coupled to the line buffer 410 is used to compare each pixel data in the current line data ODATA with another pixel data in the previously stored line data BDATA at both data's corresponding position (or at the same position), and then to output this comparison result as the control signal CS. The pass gate 430 coupled to the comparator 420 is used to receive the current line data ODATA and determine whether to pass the current line data ODATA through the pass gate 430 and the data bus DATA[0:n−1] to the data-latching unit 333 in the source driver 330. In this embodiment, a buffer 440 is further disposed between the pass gate 430 and the data-latching unit 333.

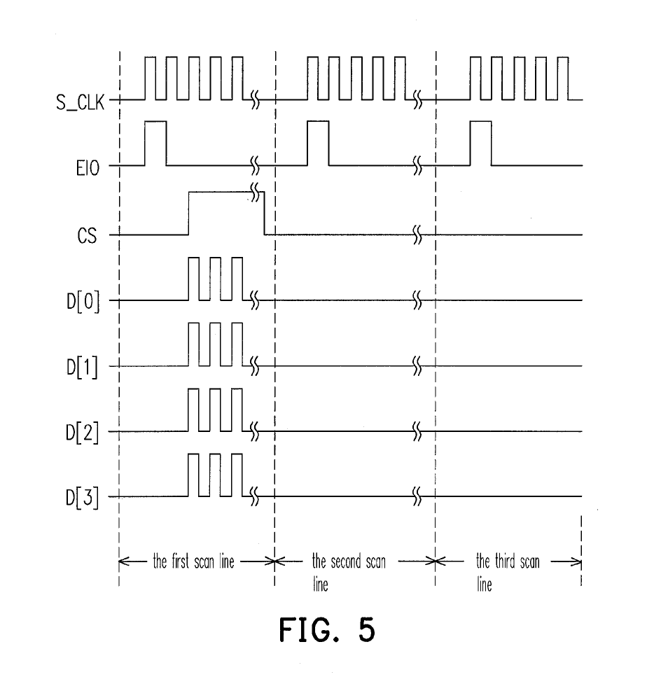

For simplifying the description of this embodiment, it is assumed that each pixel data has 256 grey scales and a RSDS technology is used as an interface (i.e. the rising edge and the falling edge of the clock signal are both used as latching signals) between the timing controller 110 and the source driver 130. FIG. 5 shows signal timing charts of a whole picture with a grey scale of 85 (i.e. pixel data is 01010101) transmitted by the timing controller 310 according to the present invention, as shown in FIG. 4. Referring to FIG. 4 and FIG. 5, as the rising edge and the falling edge of the clock signal are both used as latching signals, during a clock signal period, each bit line of the data bus DATA[0:n−1] is able to transmit two bits of data. Consequently, the 0^{th} and 1^{st} bits of the pixel data ┌01010101┘ are transmitted to the data-latching unit 333 through the data bus DATA[0], the 2^{nd} and 3^{th} bits of the pixel data ┌01010101┘ are transmitted to the data-latching unit 333 through the data bus DATA[1], and so on.

When the timing controller 310 starts to transmit the current line data ODATA of the first scan line (each pixel data is ┌01010101┘), the line buffer 410 receives and stores the current line data ODATA of the first scan line. Currently, as there is no current line data ODATA provided for comparison in a previous scan line, the comparison result is surely “non-identical” (here, for example, the logic “high” level of the control signal represents “non-identical” status). The pass gate 430 is controlled by the comparator 420 so that when the control signal is a logic “high,” the pass gate 430 allows the current line data ODATA to pass through the buffer 440 and the data bus DATA[0:n−1], thereby transmitting the current line data ODATA to the input terminal of each D-type Flip-Flop in the data-latching unit 333. In the meantime, each D-type Flip-Flop in the data-latching unit 333 respectively, in accordance with the second latching signal output from the latch control unit (i.e. the shift register 331 and the control unit 332), latches its corresponding pixel data in the current line data ODATA and respectively outputs the latched corresponding pixel data to the output-converting unit 334.

When the timing controller 310 starts to transmit the current line data ODATA of the second scan line, the line buffer 410 receives and stores the current line data ODATA of the second scan line while outputting the previously stored first scan line data (i.e. the previous line data ODATA). The comparator 420 compares each pixel data at its corresponding position (or at the same position) between the current line data ODATA and the previous line data BDATA, and then outputs this comparison result as a control signal CS. If a certain pixel data in current line data ODATA and that in the previous line data BDATA are not identical, the comparator 420 outputs an enable control signal CS at a timing corresponding to the certain pixel data (a logic “high” status, for example) so as to indicate the comparison result of the certain one pixel data is “non-identical.” On the contrary, if a certain pixel data in current line data ODATA and that in the previous line data BDATA are identical, the comparator 420 outputs a disable control signal CS at a timing corresponding to the certain pixel data (a logic “low” status, for example) so as to indicate the comparison result of the certain pixel data is “identical.”

That is, in one embodiment, the comparator 420 compares a certain part of the pixel data within the current line data with a corresponding part of the pixel data within the previous line data without having to compare other remaining part of the pixel data except for the part within the current line data with other remaining part of the pixel data within the previous line data. If the comparing result is that the part of the pixel data within the current line data with the corresponding part of the pixel data within the previous line data are not identical, the comparator 420 outputs an enable control signal CS at a timing corresponding to the certain pixel data (a logic “high” status, for example) so as to indicate the comparison result of the certain one pixel data is “non-identical.” If the comparing result is that the part of the pixel data within the current line data with the corresponding part of the pixel data within the previous line data are identical to each other, the comparator 420 outputs a disable control signal CS at a timing corresponding to the certain pixel data (a logic “low” status, for example) so as to indicate the comparison result of the certain pixel data is “identical.”

As the grey scale of each pixel data in the whole figure is assumed to be 85 in this embodiment, each pixel data in the second scan line and that in the first scan line are identical (i.e. their grey scales are 85). Hence, at this moment, the comparator 420 outputs a disable control signal CS (i.e. a logic “low”) to indicate the comparison result is “identical.” When the control signal CS is the logic “low,” the comparator 420 stops the current line data ODATA to pass through and outputs the logic “low” signal to the input terminal of each D-type Flip-Flop in the data-latching unit 333 through the buffer 440 and the data bus DATA[0:n−1]. Meanwhile, the control unit 332 blocks the shift register 331 from transmitting the second latching signal to the data-latching unit 333 since the control signal CS′ is a logic “low”, so that each D-type Flip-Flop in the data-latching unit 333 can keep the previously latched data because a new data is not written. Then, each D-type Flip-Flop in the data-latching unit 333 outputs the pixel data latched therein to the output-converting unit 334.

Therefore, evidently, it can be seen from FIG. 5 that when the pixel data at its corresponding position in the previous line data and the later line data (i.e. scan line data) are identical, the source driver directly uses the previously latched pixel data, rather than transmitting the pixel data repeatedly. Hence, an amount of transmitted data required for displaying pictures is reduced, which further reduces the power consumption and electromagnetic interference (EMI).

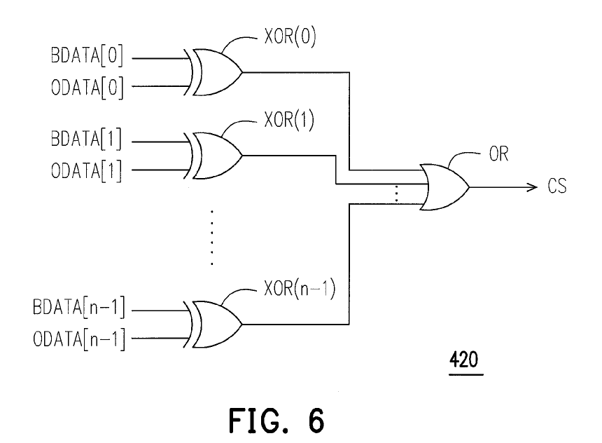

The comparator 420 may be implemented by referring to FIG. 6. The comparator 420 comprises a plurality of exclusive-OR gates, denoted by XOR(0)˜XOR(n−1), and an OR gate. The XOR(0)˜XOR(n−1) respectively receive corresponding bit data of the pixel data in the current line data ODATA and that in the previous line data BDATA. The OR gate receives the outputs of the XOR(0)˜XOR(n−1) and then outputs the control signal CS.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for driving a display panel, comprising:
a comparison unit, receiving and storing a current line data, wherein the comparison unit has received a previous line data before receiving the current line data, wherein the previous line data comprises a plurality of previous pixel data and the current line data comprises a plurality of current pixel data, and the plurality of previous pixel data are positionally corresponding to the current pixel data respectively, wherein the comparison unit compares a predetermined one of the plurality of the current pixel data with a corresponding one of the plurality of previous pixel data, wherein when the predetermined one current pixel data and the corresponding one previous pixel data are not identical, the comparison unit outputs an enable control signal and the current line data; and when the predetermined one current pixel data and the corresponding one previous pixel data are identical, the comparison unit outputs a disable control signal and does not output the current line data; and
a source driver coupled to the comparison unit, latching the current line data output from the comparison unit and then driving the display panel in accordance with the current line data when a control signal is the enable control signal, or driving the display panel in accordance with the previous latched line data when the control signal is the disable control signal.

2. The apparatus of claim 1, wherein the comparison unit comprises:
a line buffer, receiving the current line data and outputting the previously stored line data;
a comparator coupled to the line buffer, comparing each pixel data in the current line data with another pixel data in the previously stored line data at the same position one by one, and then outputting the comparison result as the control signal; and
a pass gate coupled to the comparator, receiving the current line data and determining whether to pass the current line data through the pass gate to the source driver, wherein the pass gate outputs a logic “low” to a data-latching unit when the comparator determines the pixel data within the current line data and another pixel data within the previous line data at the same position are identical.

3. The apparatus of claim 2, wherein the comparator comprises:
a plurality of exclusive-OR gates, respectively receiving corresponding bit data of the pixel data in the current line data and that in the previous line data; and
an OR gate, receiving the outputs of the exclusive-OR gates and then outputting the control signal.

4. The apparatus of claim 1, wherein the comparison unit is disposed in a timing controller that outputs a source clock signal and a first latching signal and wherein the source driver at least comprises:
a shift register having a plurality of output terminals, transmitting the received first latching signal by stages inside the shift register and outputting the second latching signal at one of the output terminals in accordance with a timing of the source clock signal;
a control unit coupled to the output terminals of the shift register, determining whether to pass the second latching signal through the control unit in accordance with the control signal output from the comparison unit;
a data-latching unit coupled to the control unit, determining whether to latch the current line data output from the comparison unit in accordance with the second latching signal output from the control unit; and
an output-converting unit coupled between the data-latching unit and the display panel, converting each line data latched inside the data-latching unit into an analog data for driving a plurality of data lines in the display panel.

5. The apparatus of claim 4, wherein the control unit comprises:
a plurality of switches, comprising a first terminal coupled to its corresponding output terminal of the shift register, a second terminal coupled to its corresponding latch control terminal of the data-latching unit, and a control terminal receiving the control signal for determining whether to turn on the first terminal and second terminal according to the control signal.

6. The apparatus of claim 5, wherein the switches are N-type transistors.

7. The apparatus of claim 1, wherein the display panel is a liquid crystal display panel.

8. An apparatus for driving a display panel, comprising:
a comparison unit, having previously received a previous line data comprising a plurality of previous pixel data and storing a current line data comprising a plurality of current pixel data, wherein the plurality of previous pixel data and the plurality of current pixel data are positionally corresponding to each other respectively, wherein the comparison unit compares a predetermined one of the plurality of current pixel data with the corresponding one of the plurality of previous pixel data, and outputs a control signal and determining whether to output the current line data in accordance with the comparison result;
a latch control unit coupled to the comparison unit, outputting a plurality of latching signals and determining whether to output each latching signal in accordance with the control signal output from the comparison unit;
a data-latching unit coupled to the latch control unit, determining whether to latch corresponding pixel data in the current line data output from the comparison unit in accordance with the latching signals output from the latch control unit; and
an output-converting unit coupled between the data-latching unit and the display panel, converting data latched inside the data-latching unit into an analog data for driving a plurality of data lines in the display panel.

9. The apparatus of claim 8, wherein when a pixel data within the current line data and another pixel data within the previous line data at the same position are not identical, the comparison unit outputs an enable control signal to enable the data-latching unit to latch the current line data through the latch control unit; and when the pixel data within the current line data and another pixel data within the previous line data at the same position are identical, the comparison unit does not output the current line data but output a disable control signal enabling the data-latching unit to keep the previously latched line data through the latch control unit.

10. The apparatus of claim 8, wherein the comparison unit comprises:
a line buffer, receiving the current line data and outputting the previously stored line data;
a comparator coupled to the line buffer, comparing each pixel data in the current line data with another pixel data in the previously stored line data at the same position, and then outputting the comparison result as the control signal; and
a pass gate coupled to the comparator, receiving the current line data and determining whether to pass the current line data through the pass gate to the source driver, wherein the pass gate outputs a logic “low” to a data-latching unit when the comparator determines the pixel data within the current line data and another pixel data within the previous line data at the same position are identical.

11. The apparatus of claim 10, wherein the comparator comprises:
a plurality of exclusive-OR gates, respectively receiving corresponding bit data of the pixel data in the current line data and that in the previous line data; and
an OR gate, receiving the outputs of the exclusive-OR gates and then outputting the control signal.

12. The apparatus of claim 8, wherein the control unit comprises:
a plurality of switches, comprising a first terminal coupled to its corresponding output terminal of the shift register, a second terminal coupled to its corresponding latch control terminal of the data-latching unit, and a control terminal receiving the control signal to determine whether to turn on the first terminal and second terminal according to the control signal.

13. The apparatus of claim 12, wherein the switches are N-type transistors.

14. The apparatus of claim 8, wherein the display panel is a liquid crystal display panel.

15. A method for driving a display panel, comprising:
receiving and storing a previous line data comprising a plurality of previous pixel data;
receiving and storing a current line data comprising a plurality of current pixel data, wherein the plurality of current pixel data and the plurality of previous pixel data are corresponding to each other respectively;
comparing a predetermined one of the plurality of current pixel data with the corresponding one of the plurality of previous pixel data;
latching a pixel data within the current line data into the source driver, when the pixel data within the current line data and another pixel data within the previous line data at the same position are not identical; and
enabling the source driver to keep the previously latched pixel data when the pixel data within the current line data and another pixel data within the previous line data at the same position are identical;
enabling the source driver to drive the display panel in accordance with each internal latched pixel data.

16. The method of claim 15, further comprising:
providing the current line data to the source driver when the pixel data within the current line data and another pixel data within the previous line data at the same position are not identical; and
providing a logic “low” to the source driver when the pixel data within the current line data and another pixel data within the previous line data at the same position are identical.

17. The method of claim 15, wherein the step of comparing the current line data with a previous stored line data comprises:
comparing the pixel data within the current line data and another pixel data within the previous line data at the same position one by one.

18. The method of claim 15, wherein the display panel is a liquid crystal display panel.

19. An apparatus for driving a display panel, comprising:
a comparison unit, receiving and storing a current line data, wherein the comparison unit has received a previous line data before receiving the current line data, wherein the comparison unit compares only a part of the current line data with the corresponding part of the previous line data, wherein when the part of current line data and the corresponding part of previous line data are not identical, the comparison unit outputs an enable control signal and the current line data; and when the predetermined one current pixel data and the corresponding one previous pixel data are identical, the comparison unit outputs a disable control signal and does not output the current line data; and
a source driver coupled to the comparison unit, latching the current line data output from the comparison unit and then driving the display panel in accordance with the current line data when a control signal is the enable control signal, or driving the display panel in accordance with the previous latched line data when the control signal is the disable control signal.

20. A method for driving a display panel, comprising:
receiving and storing a previous line data;
receiving and storing a current line data;
comparing only a part of the current line data with a corresponding part of the previous line data;
latching a pixel data within the current line data into the source driver, when the part of the current line data and the corresponding part of the previous line data being compared are not identical; and
enabling the source driver to keep the previously latched pixel data when the part of the current line data and the corresponding part of the previous line data being compared are identical;
enabling the source driver to drive the display panel in accordance with each internal latched pixel data.
